(19) United States
(12) Patent Application Publication
(10) Pub. No.: US 2026/0210534 A1
(43) Pub. Date: Jul. 23, 2026

(54) PANEL LIGHTS WITH LOW VOLTAGE MOUNT PLATE

(71) Applicant: GLOBE ELECTRIC COMPANY INC., Montreal (CA)

(72) Inventors: Edgar Lopez, Montreal (CA); Miles William McDonald, Bowling Green, KY (US); Costas Politakis, Montreal (CA); Scott Blaise Tylicki, Bowling Green, KY (US)

(21) Appl. No.: 19/456,859

(22) Filed: Jan. 22, 2026

Related U.S. Application Data
(60) Provisional application No. 63/748,705, filed on Jan. 23, 2025.

(51) Int. Cl. F21V 21/03; F21S 8/04; F21V 23/00; F21Y 113/00; F21Y 115/10

(52) U.S. Cl. CPC F21V 21/03; F21S 8/04; F21V 23/003; F21Y 2113/00; F21Y 2115/10

(57) ABSTRACT

Systems, devices, apparatuses, and methods for attaching and detaching a ceiling light. A mounting plate of a ceiling light may electrically connect with a light panel of the ceiling light using a plug and outlet connection. A mounting plate of a ceiling light may mechanically connect with a light panel of a ceiling light using one or more mechanical projections. Simultaneous electrical and mechanical connections between a mounting plate of a ceiling light and a light panel of a ceiling light may occur based on displacement of the light panel of the ceiling light relative to the mounting plate of the ceiling light.

### FIELD

Implementations discussed herein relate to light fixtures (including troffer-style ceiling light fixtures). For example, implementations discussed herein relate to systems, devices, apparatuses, and methods for attaching and detaching a light panel of a light fixtures with a mounting plate of a light fixture.

### BACKGROUND

Light fixtures may be used to illuminate dark areas. Light fixtures may be mounted to a ceiling. Light fixtures may attach to an electricity source using various means, including wire nuts and/or crimping. Troffer lights may require a user to secure a light panel adjacent to a ceiling (e.g., using temporary cables) to provide an accessible opening that is close enough to the ceiling for electric connections located in a ceiling junction box to connect with electrical connections of the light panel, while simultaneously being far enough away from the ceiling to permit access for a user to electrically fasten the connections. Construction and installation of troffer lights may therefore require tedious management of the temporary securement means (such as temporary ceiling cables). Construction and installation for troffer lights may also require users to physically handle electrical connections while installing, navigating around, and removing the temporary securing means.

### SUMMARY

Disclosure herein relates to ceiling lights (including troffer-style ceiling lights). The disclosure herein provides systems, devices, apparatuses, and methods for attaching and detaching a light panel of a ceiling fan light with a mounting plate of a ceiling light.

Disclosure herein provides for troffer lights which may circumvent and/or alleviate the requirement for temporary securement means (e.g., temporary cables), and the management thereof. For example, disclosure herein provides for a mounting plate that may be electrically connected to a circuit and mechanically mounted to a surface, and for a light panel to be subsequently positioned adjacent to the mounting plate and shifted relative to the mounting plate, wherein the mounting plate and the light panel may approximately simultaneously connect both electrically and mechanically in response to the light panel being subsequently positioned adjacent to the mounting plate and shifted relative to the mounting plate.

As another example, disclosure herein provides for a mounting plate to be electrically connected to a circuit and mechanically mounted to a surface, and for a first side of a light panel to be mechanically connected to a first side of a mounting plate (e.g., by hook and notch), and for the second side of the light panel to be mechanically connected to a second side of the mounting plate (e.g., by lever and notch) responsive to movement (e.g., rotation) of the light panel towards the mounting plate about and/or around the mechanical connection of the first side of the light panel and the first side of the mounting plate, wherein electrical connection between the light panel and the mounting plate occurs approximately simultaneously to the second side of the light panel and the second side of the mounting plate mechanically connecting.

Disclosure herein would also alleviate the requirement to physically manage electrical connections while installing, navigating around, and/or removing temporary securement means between a light panel and mounting plate. For example, disclosure herein provides for troffer lights that may include a mounting plate which may be mechanically connected to a surface, and which may be electrically connected to circuity. Disclosure herein provides that a mounting plate may include an electrical connection which may electrically connect with an electrical connection of a light panel in response to the light panel being positioned and/or shifted adjacent to the mounting plate (e.g., as opposed to the light panel only mechanically connecting with the mounting plate). Light panels may approximately simultaneously connect with mounting plates both electrically and mechanically based on adjacent positioning and/or shifting relative to each other. This may alleviate the requirement to pull electrical connections through an aperture of a mounting plate, temporarily position a light panel adjacent to the mounting plate using temporary securement means (e.g., cables), navigate around the temporary securement means while electrically connecting the light panel with the electrical connections, and subsequently removing the temporary securement means and mechanically securing the light panel to the mounting plate.

Disclosure herein may therefore improve convenience, efficiency, and safety when installing a troffer light.

### DESCRIPTION OF THE DRAWINGS

FIG. 1A depicts a top-down perspective view of a mounting plate of a first embodiment discussed herein.

FIG. 1B depicts a bottom-up perspective view of a mounting plate of a first embodiment discussed herein.

FIG. 2A depicts a top-down perspective view of a light panel of a first embodiment discussed herein.

FIG. 2B depicts a top-down enlarged perspective view of a light panel of a first embodiment discussed herein.

FIG. 3A depicts a top-down perspective view of a connected mounting plate and light panel of a first embodiment discussed herein.

FIG. 3B depicts a top-down enlarged perspective view of a connected mounting plate and light panel of a first embodiment discussed herein.

FIG. 3C depicts a top-down enlarged perspective view of a mounting plate projection and a light panel projection of a first embodiment discussed herein.

FIG. 3D is a top-down perspective view of a mounting plate and a light panel of a first embodiment discussed herein.

FIG. 4 depicts a bottom-up perspective view of a mounting plate of a second embodiment discussed herein.

FIG. 5A depicts a top-down perspective view of a mounting plate and a light panel of a second embodiment discussed herein.

FIG. 5B depicts another top-down perspective view of a mounting plate and a light panel of a second embodiment discussed herein.

FIG. 6A depicts a top-down perspective view of a mounting plate and a light panel of a second embodiment discussed herein with modifications.

FIG. 6B depicts another top-down perspective view of a mounting plate and a light panel of a second embodiment discussed herein with modifications.

FIG. 7 depicts a side view of a mounting plate and a light panel of a second embodiment discussed herein.

FIG. 8 depicts a front view of a mounting plate and a light panel of a second embodiment discussed herein.

FIG. 9A depicts an enlarged side view of a mounting plate and a light panel of a second embodiment discussed herein, with a locking tab of a hooked mounting plate projection open.

FIG. 9B depicts an enlarged side view of a mounting plate and a light panel of a second embodiment discussed herein, with a locking tab of a hooked mounting plate projection closed.

FIG. 9C depicts a perspective view of a hooked mounting plate projection, a hooked mounting plate latch, and a notched light panel projection.

FIG. 9D depicts another perspective view of a hooked mounting plate projection, a hooked mounting plate projection latch, and a notched light panel projection.

FIG. 10A depicts an enlarged view of a mounting plate and a light panel of a second embodiment discussed herein, with a light panel projection lever.

FIG. 10B depicts an enlarged view a mounting plate and a light panel of a second embodiment discussed herein, with another light panel projection lever.

FIG. 10C depicts a cross-sectional perspective view of a spring assisted mounting plate projection.

FIG. 10D depicts another perspective view of the spring assisted mounting plate projection.

FIG. 10E depicts a perspective view of a notched light panel projection.

FIG. 11 is a bottom-up perspective view of a light panel of a second embodiment discussed herein.

FIG. 12 depicts a cross-sectional representation of circuitry of a light panel of a second embodiment discussed herein

FIG. 13 depicts a schematical representation of circuitry of one or more light panel embodiments discussed herein.

### DETAILED DESCRIPTION

Disclosure discussed herein may relate to light fixtures. Specifically, disclosure discussed herein may relate to troffer-style ceiling light fixtures.

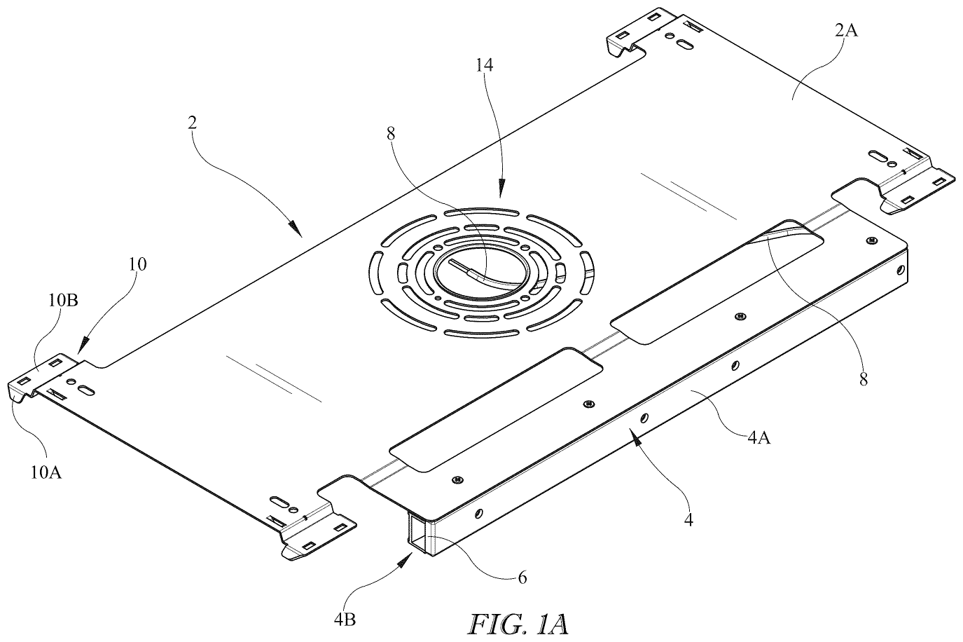

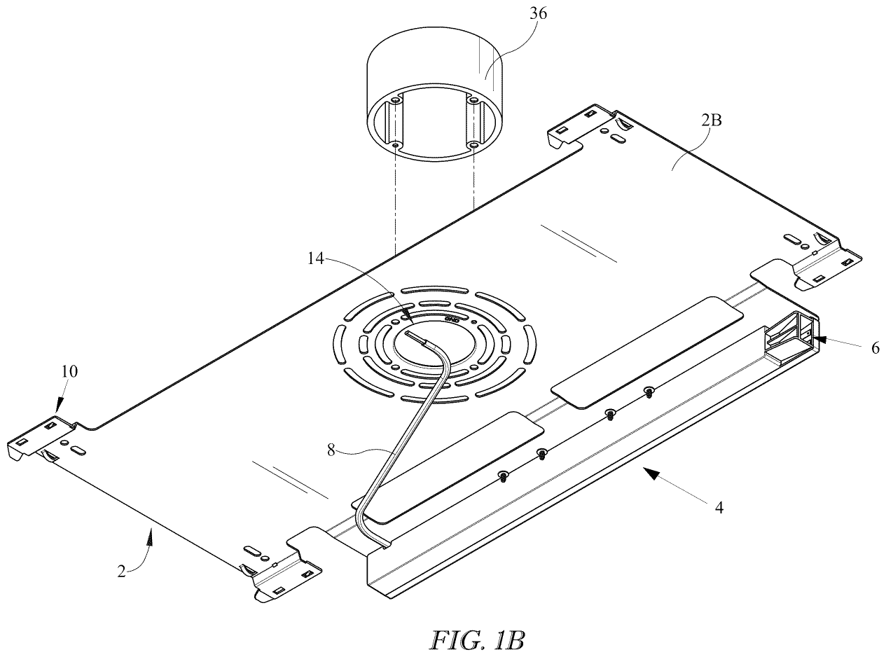

FIG. 1A depicts a top-down perspective view of a mounting plate of a first embodiment discussed herein. Top surface 2A of mounting plate 2 is depicted in FIG. 1A. Mounting plate 2 may include one or more of an electronic driver 4, mounting plate projection 10, and mounting plate aperture 14. Mounting plate 2 may be mounted to a surface. For example, mounting plate 2 may be mounted to a ceiling surface. In that example, top surface 2A of mounting plate 2 may be adjacent to the ceiling surface. Mounting plate 2 may be mounted directly to a ceiling surface and/or mounted to a junction box of a ceiling surface. Mounting plate 2 may receive one or more fasteners securing the mounting plate to an adjacent surface. Mounting plate 2 may be secured to a ceiling surface and/or junction box using one or more fasteners. Mounting plate 2 may include one or more notches for fasteners to travel through.

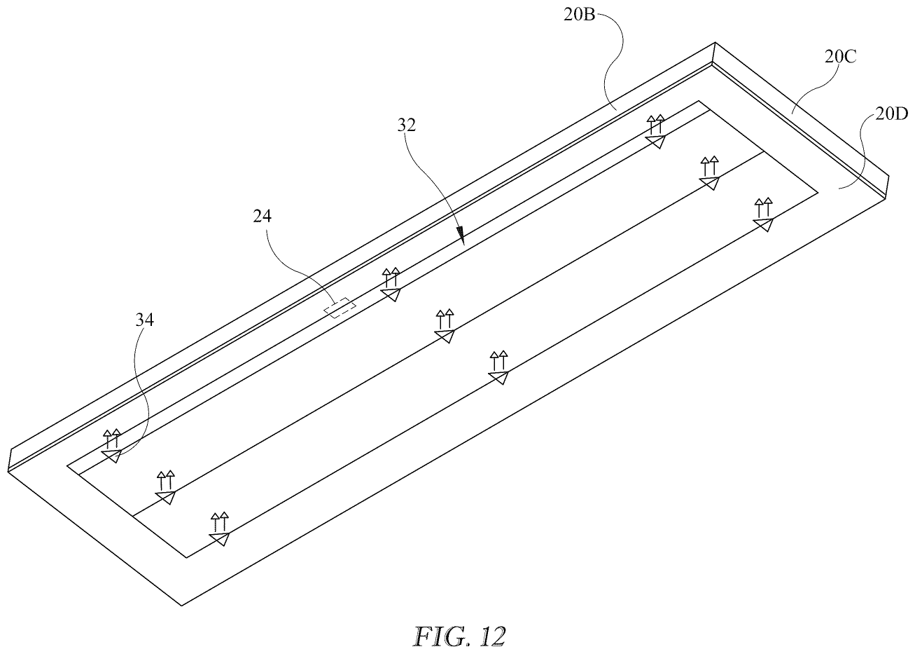

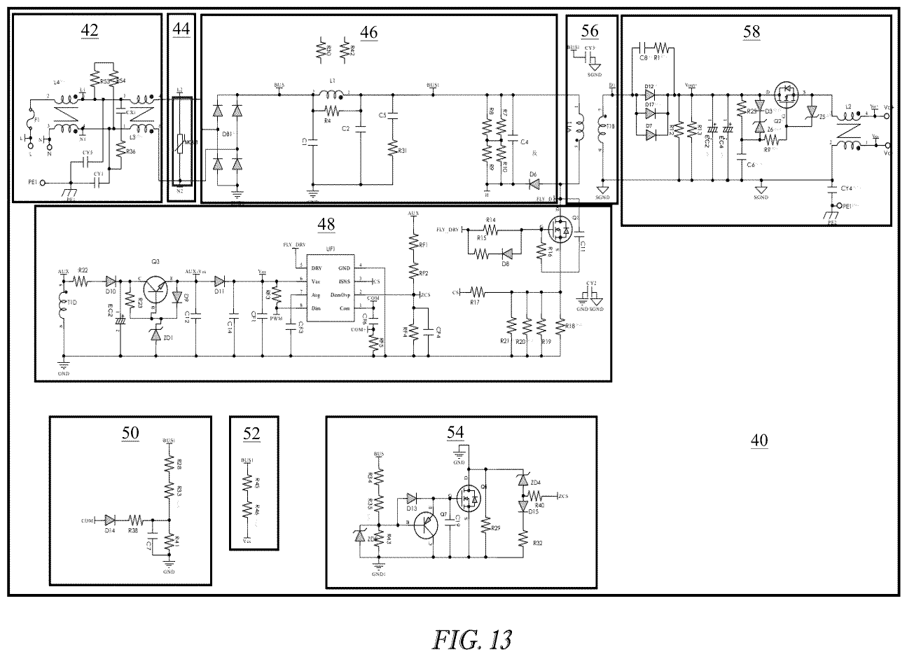

Electronic driver 4 may be located on mounting plate 2. Electronic driver 4 may drive one or more electronic components discussed herein. For example, as discussed in more detail subsequently, electronic driver 4 may drive circuitry of a light panel, including an LED, that may be electrically connected to mounting plate 2. Electronic driver 4 may include a low voltage driver outlet 6. Electronic driver 4 may be connected to an electricity source via conductor 8. Electronic driver 4 may modify features of electricity received from an electricity source. For example, electronic driver 4 may transform current or voltage, modulate frequency, etc. Electronic driver 4 may include and/or be electrically connected with circuitry discussed herein, including circuitry discussed in more detail in FIGS. 12-13. Electronic driver 4 may be of various configurations, shapes, and sizes. Electronic driver 4 may be located on one or more points of mounting plate 2. As depicted in FIG. 1A, electronic driver 4 may be a rectangular prism extending from mounting plate 2. A longitudinal side 4A of electronic driver 4 may attach to mounting plate 2.

Low voltage driver outlet 6 may be located on one or more points of electronic driver 4. As depicted in FIG. 1, low voltage driver outlet 6 is depicted on one lateral side 4B of electronic driver 4. Low voltage driver outlet 6 may provide low voltage electricity to an electronic component discussed herein. For example, as discussed in more detail subsequently, low voltage driver outlet 6 may provide low voltage electricity to an LED of a light panel. Low voltage driver outlet 6 may connect and/or disconnect with an electronic component. A connection between low voltage driver outlet 6 and an electronic component may be electrical and/or mechanical. Low voltage driver outlet 6 may be of various configurations, shapes, and sizes, and may be located on different areas of electronic driver 4.

Conductor 8 may connect electronic driver 4 to an electricity source. Conductor 8 may include circuit wiring, connections, etc. Conductor 8 may travel through a mounting plate aperture 14. For example, mounting plate 2 may be mounted to a junction box of a ceiling surface, and based on the location of electronic driver 4, it may be aesthetically and/or structurally appealing to route conductor 8 from electronic driver 4 through mounting plate aperture 14 so that conductor 8 may electrically connect with an electricity source, such as a line voltage source.

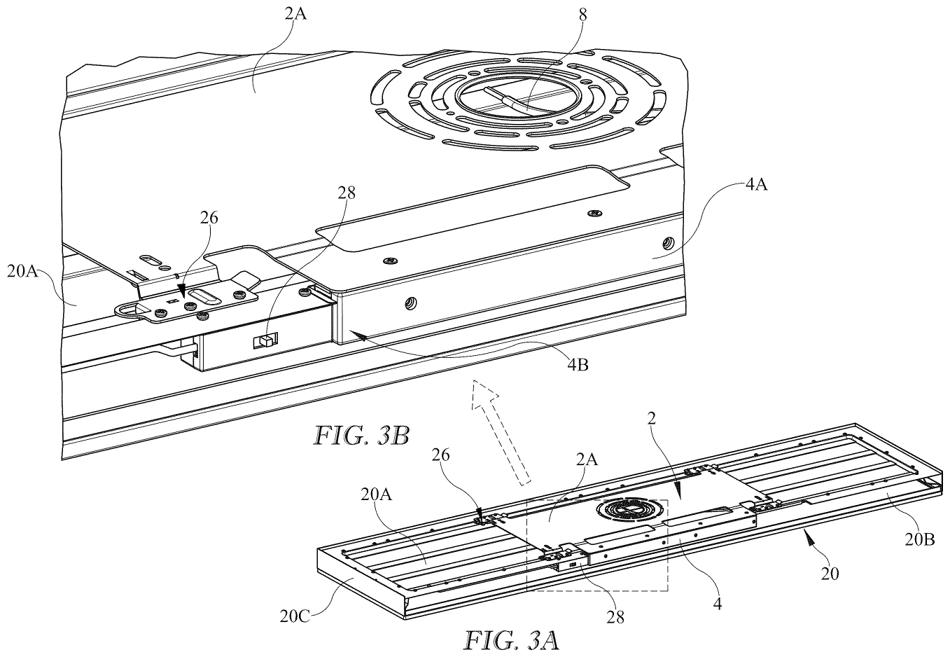

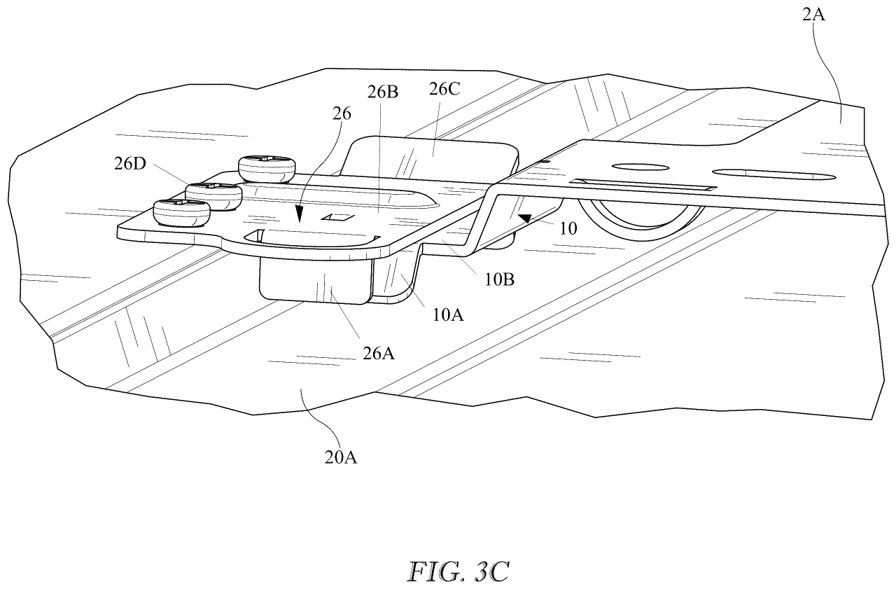

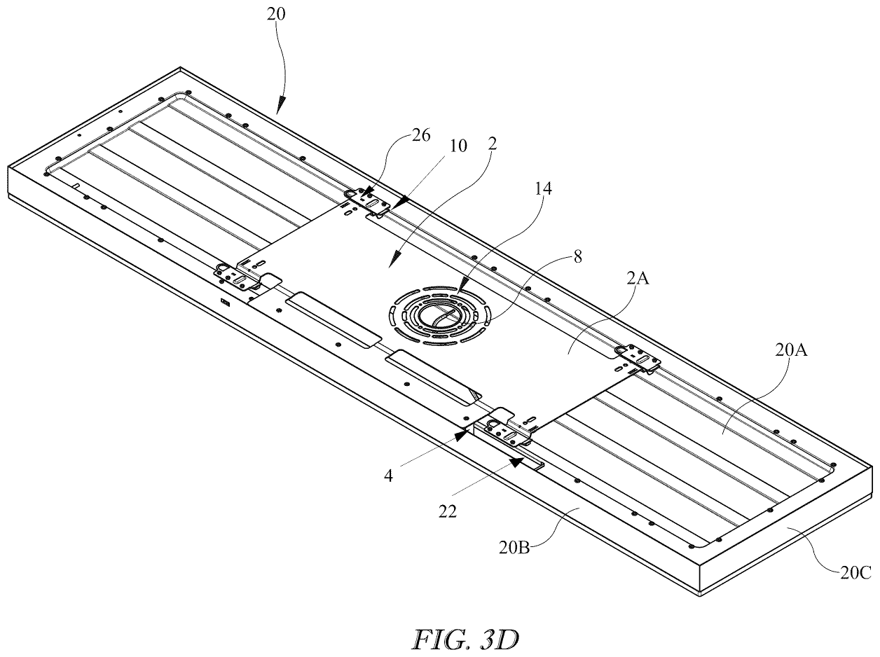

Mounting plate projection 10 may be located at one or more points of mounting plate 2. Mounting plate projection 10 may be various configurations, shapes, and sizes. As depicted in FIG. 1, mounting plate projection 10 may extend from a corner of mounting plate 2. Mounting plate projection 10 may include a plate 10B and a ramp 10A. Mounting plate projection 10 (and corresponding light panel projections) will be discussed in greater detail in FIG. 3C.

Embodiments discussed herein may include a plurality of components discussed herein, even if said components are referenced singularly for the sake of brevity. For example, there may be a plurality of mounting plate projections 10, such as one at each corner of mounting plate 2. As another example, there may be multiple conductors 8 (e.g. a line and neural voltage conductor). Put another way, one or more of any of the components disclosed herein may be included in embodiments disclosed herein. Exact quantities, configurations, shapes, sizes, locations, etc., of components disclosed herein are used only as examples.

Mounting plate 2 may be installed on a ceiling surface and/or wired to an electricity source prior to connecting (either mechanically or electrically) with a light panel. As discussed in more detail herein, a light panel may be capable of simultaneously mechanically and electrically connecting with a mounting plate 2. For example, a light panel may be attached to mounting plate 2 after mounting plate 2 has been installed on a ceiling and/or wired to an electricity source. This may improve convenience, efficiency, and safety when installing a light panel.

It may be easier to manage and connect electrical connections (e.g., between conductor 8 and a line source connection) while only navigating them through mounting plate 2 than to navigate electrical connections through a mounting plate (e.g., that is already installed on a ceiling) and manage and connect electrical connections with a light panel that is temporarily held closely beneath the mounting plate (e.g., by temporary cables). These improvements are compounded when considering that a space between a mounting plate and a light panel hanging by cables may only be a few inches (based on finite lengths of temporary cables, and finite. lengths of conductors, etc.) which may reduce navigable space for a user to manage electrical connections. These improvements may be further compounded when considering that a ceiling may be directly above mounting plate, which may also reduce a user's line of sight between electrical connections.

FIG. 1B is a bottom-up perspective view of a mounting plate discussed herein.

Mounting plate 2 may be connected to junction box 36. Conductor 8 may be connected with an electricity source of junction box 36. For example, a household line voltage source may be located in junction box 36, and conductor 8 may connect with the household line voltage source. Connection between conductor 8 and the household line voltage source may energize components discussed herein. For example, connection between conductor 8 and the household line voltage source may energize electronic driver 4, and may also energize circuitry (including LEDs) of a light panel based on connection with electronic driver 4.

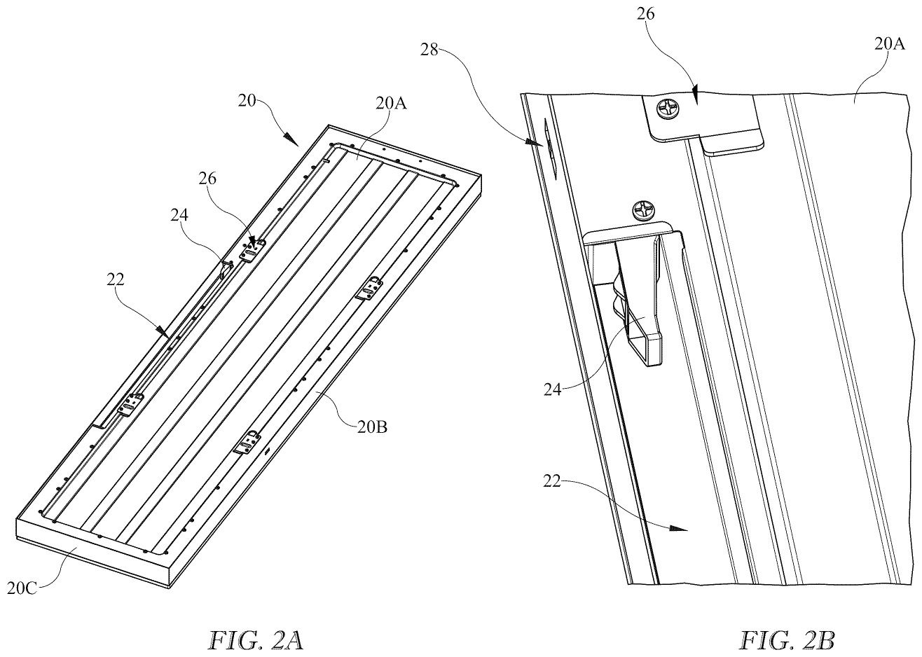

FIG. 2A depicts a top-down perspective view of a light panel of a first embodiment discussed herein. Light panel 20 may include one or more of a channel 22, a low voltage connector 24, and a light panel projection 26. Some components not depicted in FIG. 2A may also be included in light panel 20, such as circuitry and one or more light sources (discussed in more detail subsequently in FIGS. 12-13). Light panel 20 may have a top surface 20A, a longitudinal side 20B and a lateral side 20C.

Channel 22 may receive electronic driver 4. Channel 22 may be larger than electronic driver 4 so that it may receive electronic driver 4. Channel 22 may be deep enough, wide enough, and long enough to receive electronic driver 4. Put another way, channel 22 may be deeper, wider, and/or longer than electronic driver 4.

Low voltage connector 24 may extend outwardly from light panel 20 into channel 22. As depicted in FIG. 2A, low voltage connector 24 may be a tongue connection, which may connect with a groove connection of low voltage driver outlet 6. For example, channel 22 may receive electronic driver 4, and electronic driver 4 may slide within channel 22 towards low voltage connector 24. Low voltage connector 24 and low voltage driver outlet 6 may connect based on electronic driver 4 sliding within channel 22 towards low voltage connector 24. For example, low voltage driver outlet 6 may face low voltage connector 24 when electronic driver 4 is received in channel 22, and may connect when electronic driver 4 slides towards low voltage connector 24. Low voltage connector 24 and low voltage driver outlet 6 may be connected using various electrical joinery, including socket and plug configurations, contact pad configurations, induction pad configurations, etc.

Light panel projection 26 may be located at one or more points of light panel 20. Light panel projection 26 may be various configurations, shapes, and sizes. Light panel projection 26 may connect with mounting plate projection 10. Put another way, light panel projection 26 may attach and detach from mounting plate projection 10. Referring briefly to FIGS. 1A and 1B, mounting plate projections 10 may be divided into sets. Light panel projections 26 may also be divided into sets.

A set of light panel projections 26 may correspond with a set of mounting plate projections 10. For example, a first set of light panel projections 26 on a first longitudinal side of light panel 20 may correspond with a first set of mounting plate projections 10 along a first longitudinal side of mounting plate 2, and a second set of light panel projections 26 on an opposing second side of light panel 20 may correspond with a second set of mounting plate projections along an opposing second side of mounting plate 2.

FIG. 2B depicts a top-down enlarged perspective view of a light panel of a first embodiment discussed herein. Low voltage connector 24 may be angled. An angle of low voltage connector 24 may guide low voltage connector 24 into low voltage driver outlet 6. Low voltage connector 24 may be at least electrically connected with low voltage driver outlet 6, based on low voltage connector 24 being guided into low voltage driver outlet 6.

Channel 22 may receive electronic driver 4 adjacent to low voltage connector 24. Put another way, electronic driver 4 may be received in a first portion of channel 22, and a second portion of channel 22 (that low voltage connector 24 extends into, and that may not currently be occupied by electronic driver 4) may be adjacent to the first portion of channel 22 (that received electronic driver 4, and that electronic driver 4 may currently occupy). Electronic driver 4 may slide within channel 22 from the first portion of channel 22 that electronic driver 4 was received in towards the second portion of channel 22 that includes low voltage connector 24. Put another way, as electronic driver 4 slides to a second portion of channel 22 (e.g., towards the low voltage connector 24, in furtherance of a connection between electronic driver 4 to low voltage connector 24) it may move away from an opposing first portion of channel 22, rendering the opposing first portion accessible should electronic driver 4 slide back (e.g., away from low voltage connector 24, in an effort to disconnect electronic driver 4 from low voltage connector 24).

Switch 28 may be used to select one or more correlated color temperatures, light colors, dimming settings, and/or light patterns, associated with light which light panel 20 may emit. Switch 28 may also be used to permit, throttle, and/or cease the flow of electricity to one or more components discussed herein, which may change the state (e.g., on, off, modified, etc.) of one or more components discussed herein. In some implementations, switch 28 may include one or more sub-switches, rotary switches, varistors, etc., to control one or more functions discussed herein.

Additionally, switch 28 and/or a different switch may disconnect low voltage driver outlet 6 and low voltage connector 24. For example, a user pressing a disconnect switch may cause low voltage connector 24 to electrically and/or mechanically detach from low voltage driver outlet 6. Put another way, low voltage connector 24 and low voltage driver outlet 6 may be detachable based on a disconnect switch being pressed. A disconnect switch may cause low voltage connector 24 to detach from a low voltage driver outlet 6 only while pressed. A disconnect switch may cause low voltage connector 24 to detach from a low voltage driver outlet 6 for a period of time after being pressed. Electronic driver 4 may or may not only be removed from channel 22 based on a disconnect switch being pressed, low voltage connector 24 detaching from low voltage driver outlet 6, electronic driver 4 sliding away from low voltage connector 24, and electronic driver 4 dropping out of channel 22. A disconnect switch may be an electrical and/or mechanical switch that is included on and/or in the light panel, for example, on and/or in a side of the light panel.

FIG. 3A depicts a top-down perspective view of a connected mounting plate and light panel of a first embodiment discussed herein.

Light panel projection 26 and mounting plate projection 10 (positioned below light panel projection 26 and supporting light panel 20, as depicted in FIG. 3A) are connected. Mounting plate projection 10 and light panel projection 26 may connect using mechanical joinery, such as tongue and groove joint, a ball and knuckle joint, etc. For example, as depicted in FIG. 3, a light panel projection 26 has slid over top of and connected with a mounting plate projection 10.

Low voltage driver outlet 6 and low voltage connector 24 are depicted as connected. Low voltage driver outlet 6 and low voltage connector 24 may connect using electrical plug connectors (e.g., male and female connectors), pad interfaces, induction, etc. Low voltage driver outlet 6 and low voltage connector 24 may connect based on channel 22 receiving electronic driver 4.

Light panel 20 may be placed against mounting plate 2. Based on channel 22 aligning with electronic driver 4 at the time that light panel 20 is placed against mounting plate 2, channel 22 may receive electronic driver 4. Low voltage connector 24 and electronic driver 4 may align for sliding electrical connection based on receipt of electronic driver 4 in channel 22. While placed against mounting plate 2, light panel 20 may be shifted from left to right, causing electronic driver 4 to be displaced from a first portion of channel 22 (not including low voltage connector 24) to a second portion of channel 22 (including low voltage connector 24). Low voltage connector 24 may be connected with low voltage driver outlet 6 based on electronic driver 4 being displaced from the first portion of channel 22 to the second portion of channel 22.

In this illustrative example, light panel 20 may be shifted from left to right (e.g., along its' longitudinal axis), causing electronic driver 4 to be displaced from a first portion of channel 22 to a second portion of channel 22. However, it is appreciated that electronic driver 4 and channel 22 may be positioned in various orientations relative to light panel 20 and mounting plate 2 respectively, such that light panel 20 may be shifted from front to back (e.g., along it's lateral axis), causing electronic driver 4 to be displaced from a first portion of channel 22 to a second portion of channel 22. Further, it is appreciated that in some implementations, the orientation and/or location of one or more of electronic driver 4 and/or channel 22 may be displaceable by a user to accommodate particular installation scenarios (e.g., which would make displacement of light panel 20 relative to mounting plate 2 in some directions more difficult than others). For example, one or more of channel 22 and/or electronic driver 4 could be on one or more of a rail assembly (allowing for locational displacement) and/or a slip-ring (allowing for orientational displacement).

Light panel projections 26 and mounting plate projections 10 may also align for sliding mechanical connection based on receipt of electronic driver 4 in channel 22. Put another way, receipt of electronic driver 4 in channel 22 may simultaneously coincide with light panel projections 26 and mounting plate projections 10 aligning. For example, receipt of electronic driver 4 in channel 22 may cause light panel projections 26 and mounting plate projections 10 to be leveled near the same height, and positioned adjacent to each other, such that when electronic driver 4 shifts side-to-side within channel 22, light panel projections 26 and mounting plate projections 10 connect or disconnect. For example, when electronic driver 4 shifts side-to-side within channel 22, light panel projections 26 may slide overtop or off of mounting plate projections 10. Mounting plate 2 and the light panel 20 may be mechanically connected based on mechanical connection between of the one or more light panel projections 26 and the one or more mounting plate projections 10.

Mechanical connection between the one or more light panel projections 26 and the one or more mounting plate projections 10 may be prohibited based on electronic driver 4 being outside of channel 22. Electrical connection between low voltage connector 24 and the low voltage driver outlet 6 may also be prohibited based on electronic driver 4 being outside of channel 22. For example, electronic driver 4 being outside of channel 22 may cause light panel projections 26 and mounting plate projections 10, as well as low voltage connector 24 and low voltage driver outlet 6, to be misaligned, such that respective mechanical and/or electrical connections are prohibited.

Simultaneous mechanical and electrical connections may be made between light panel 20 and mounting plate 2. For example, simultaneous to electronic driver shifting from a first portion of channel 22 to a second portion of channel 22 (based on light panel 20 being shifted relative to mounting plate 2) and an electrical connection between low voltage driver outlet 6 and low voltage connector 24 being made, light panel projection 26 may slide over a mounting plate projection 10 causing a mechanical connection securing light panel 20 to mounting plate 2 to also be made.

Accordingly, a user may install mounting plate 2 (e.g., by affixing mounting plate 2 to a ceiling surface and connecting conductor 8 to a line electricity source), may align light panel 20 with mounting plate 2 (such that electronic driver 4 aligns with channel 22), may raise light panel 20 adjacent to mounting plate 2 (such that electronic driver 4 is received in channel 22), and may displace light panel 20 relative to mounting plate 2 (such that low voltage connector 24 connects with low voltage driver outlet 6, and mounting plate projection 10 connects with light panel projection 26) to cause light panel 20 to simultaneously become electrically and mechanically connected with mounting plate 2.

FIG. 3B depicts a top-down enlarged perspective view of a connected mounting plate and light panel of a first embodiment discussed herein.

Low voltage connector 24 and low voltage driver outlet 6 are connected. Low voltage connector 24 and low voltage driver outlet 6 may be disconnected by a disconnect switch. While a disconnect switch is pressed, light panel 20 may be displaced relative to mounting plate 2, causing low voltage connector 24 to be displaced away from low voltage driver outlet 6 (e.g., causing electrical disconnect). Simultaneous to low voltage connector 24 being displaced away from low voltage driver outlet 6, based on light panel 20 being displaced relative to mounting plate 2, mounting plate projection 10 may be displaced from light panel projection 26 (e.g., causing mechanical disconnect). Based on light panel 20 being electrically and mechanically disconnected from mounting plate 2, light panel 20 may be dropped down away from mounting plate 2.

FIG. 3C depicts a top-down enlarged perspective view of a mounting plate projection and a light panel projection.

Light panel projection 26 may be displaced against and/or over mounting plate projection 10. Mounting plate projection 10 may include a ramp 10A, which light panel projection 26 may initially displace against, and which may facilitate light panel projection 26 displacing up and over a plate 10B of mounting plate projection 10. Light panel projection 26 may include a ramp 26C, which may initially displace against mounting plate projection 10 (or more specifically, ramp 10A) as light panel projection 26 is displaced towards mounting plate projection 10, and which may facilitate light panel projection 26 displacing up and overtop mounting plate projection 10 (or more specifically, plate 10B). Light panel projection 26 may include a backstop 26A, which may prevent light panel projection 26 from being displaced completely over and off of mounting plate projection 10. Light panel projection 26 may include a plate 26B which interfaces with plate 10B of mounting plate projection 10. Plate 26B of light panel projection 26 may rest on plate 10B of mounting plate projection 10. Fasteners 26D may secure light panel projection 26 to light panel 20. Light panel 20 may be at least mechanically connected to mounting plate 2 based on light panel projection 26 being displaced overtop mounting plate projection 10.

Light panel projection 26 may be displaced off of mounting plate projection 10. For example, after being displaced onto mounting plate projection 10, light panel projection 26 may be displaced off of mounting plate projection 10 by being displaced back towards ramp 10A until mounting plate projection 10 and light panel projection 26 are not connected. Light panel 20 may be at least mechanically disconnected from mounting plate 2 based on light panel projection 26 being displaced from mounting plate projection 10.

Light panel 20 may be rectangular and may include a light panel projection 26 adjacent to each corner. Mounting plate 2 may be rectangular and may include a mounting plate projection 10 adjacent to each corner. Each light panel projection 26 adjacent to each corner of light panel 20 may simultaneously align with each mounting plate projection 10 adjacent to each corner of mounting plate 2. Each light panel projection 26 may simultaneously be displaced against and/or over each mounting plate projection 10, thereby connecting (e.g., at least mechanically) light panel 20 to mounting plate 2. As discussed above, each light panel projection 26 may also simultaneously be displaced away from and/or off of each mounting plate projection 10, thereby disconnecting (e.g., at least mechanically) light panel projection 26 from mounting plate 2.

While illustrative examples herein may depict rectangular styles, (e.g., of mounting plates, light panels, etc.) it is appreciated that various shapes, styles, materials, and/or colors may be utilized. For example, ovular, circular, and square styles may be utilized for various components herein. For example, a mounting plate may be circular and/or ovular, and a light panel may be rectangular, such that the profile of the mounting plate may or may not be concealed by the profile of the light panel.

FIG. 3D is a top-down perspective view of a mounting plate and a light panel.

Light panel projections 26 are positioned over mounting plate projections 10. Light panel 20 is at least mechanically secured to mounting plate 2 based on light panel projections 26 being positioned over mounting plate projections 10.

Electronic driver 4 is positioned at least partially within channel 22. Low voltage outlet 6 of electronic driver 4 is connected to low voltage connector 24. Electronic driver 4 may only occupy a portion of channel 22. Channel 22 may include an unoccupied portion while electronic driver 4 is positioned in an occupied portion of channel 22.

Light panel 20 may be disconnected from mounting plate 2 by displacing electronic driver 4 towards the unoccupied portion of channel 22 and pulling light panel 20 down relative to mounting plate 2 (thereby pulling electronic driver 4 out of channel 22 as well). Based on electronic driver 4 being displaced towards the unoccupied portion of channel 22, low voltage outlet 6 of electronic driver 4 may disconnect from low voltage connector 24. Simultaneously, based on electronic driver 4 being displaced towards the unoccupied portion of channel 22, light panel projections 26 may be displaced away from and off of mounting plate projections 10. Based on low voltage outlet 6 being disconnected from electronic driver 4, and light panel projections 26 being displaced from mounting plate projections 10, light panel 20 may be displaced from mounting plate 2.

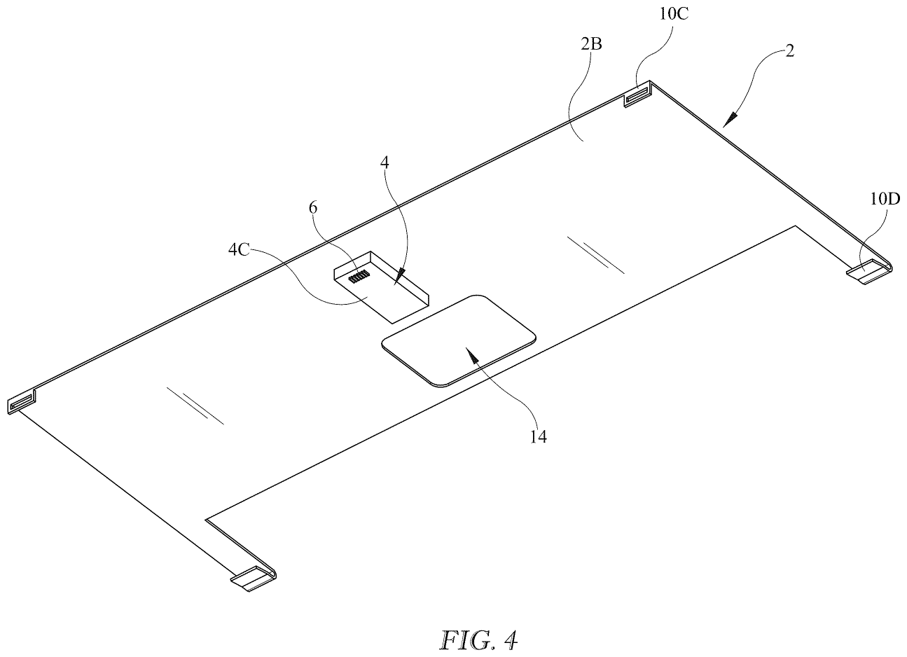

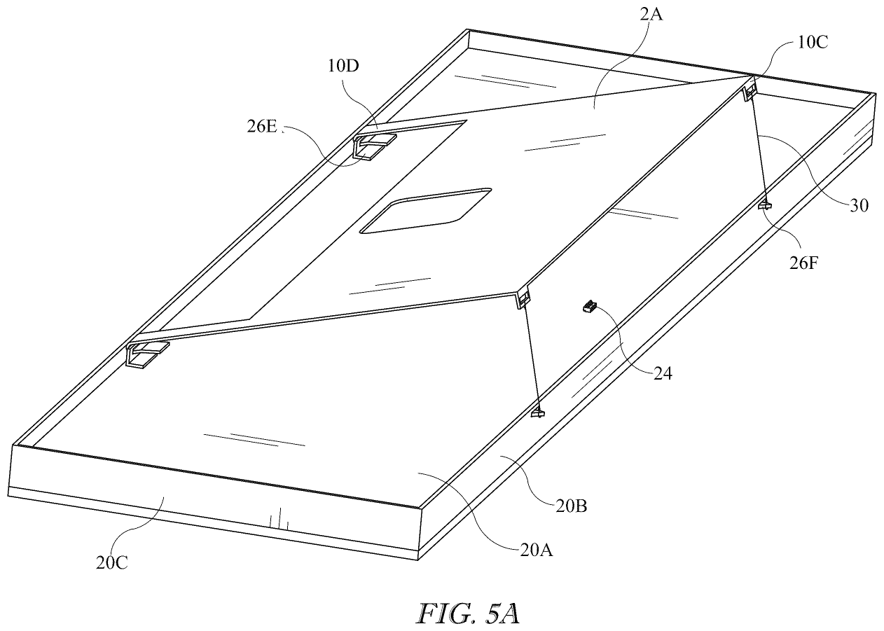

FIG. 4 depicts a bottom-up perspective view of a mounting plate of a second embodiment discussed herein. Mounting plate 2 may include hooked mounting plate projections 10D and notched mounting plate projections 10C.

Hooked mounting plate projections 10D may hook onto light panel 20. For example, hooked mounting plate projections 10D may be located only on one longitudinal side of mounting plate 2, and may hook a corresponding longitudinal side of light panel 20 to mounting plate 2. This may allow the hooked longitudinal side of light panel 20 to hang by the longitudinal side of mounting plate 2 having hooked mounting plate projections 10D while installation (e.g., such as inspection and/or wiring) is being completed. Exact configurations, shapes, sizes, locations, etc., of components discussed herein are only examples, and may be modified, substituted, and/or combined. For example, hooked mounting plate projections 10D may be located only on one horizontal side of mounting plate 2, and may hook a corresponding horizontal side of light panel 20 to mounting plate 2.

Notched mounting plate projections 10C may receive a projection of light panel 20. For example, notched mounting plate projections 10C may be located on a side of mounting plate 2 opposite of hooked mounting plate projections 10D, and may secure a corresponding side of light panel 20 (e.g., not hooked via hooked mounting plate projections 10D) to mounting plate 2. Light panel 20 may be swung about a connection with hooked mounting plate projections 10D such that notched mounting plate projections 10C may become aligned with a projection of light panel 20. Put another way, light panel 20 may be swung about a connection with hooked mounting plate projections 10D such that a side of light panel 20 that is opposite of a hooked side of light panel 20 may become aligned and/or adjacent with a side of mounting plate 2 that includes notched mounting plate projections 10C.

Electronic driver 4 may be located on a bottom surface 2B of mounting plate 2. For example, electronic driver 4 may extend from bottom surface 2B of mounting plate 2. Low voltage driver outlet 6 may be located on a bottom surface 4C of electronic driver 4. A conductor (not depicted) may connect electronic driver 4 to a line voltage source by travelling through aperture 14, and/or by travelling through mounting plate 2 and extending out of a top surface of mounting plate 2.

Mounting plate aperture 14 may be of various configurations, shapes, and sizes. As depicted in FIG. 4, mounting plate aperture 14 may be rectangular, and as depicted in FIG. 1A mounting plate aperture 14 may be circular. A conductor 8 may travel through mounting plate aperture 14.

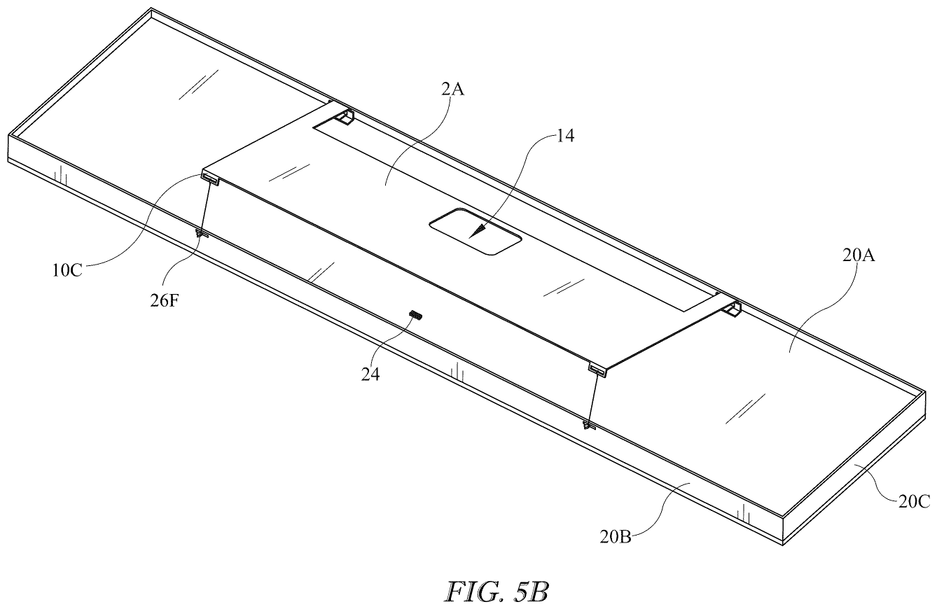

FIG. 5A depicts a top-down perspective view of a mounting plate, and a light panel of a second embodiment discussed herein.

Light panel 20 may include notched light panel projections 26E. Notched light panel projections 26E may receive hooked mounting plate projections 10D. Light panel 20 may hang from mounting plate 2 based on notched light panel projections 26E receiving hooked mounting plate projections 10D.

Light panel 20 may include a light panel projection lever 26F. Light panel projection lever 26F may be displaced relative to light panel 20. For example, light panel projection lever 26F may be rotated outwardly from light panel 20. Put another way, light panel projection lever 26F may be rotated outwardly from a wall on a longitudinal side 20B of light panel 20. Light panel projection lever 26F may be aligned with a notched mounting plate projection 10C, and may be displaced into notched mounting plate projection 10C. Put another way, notched mounting plate projection 10C may receive light panel projection lever 26F.

Light panel 20 may be secured adjacent to mounting plate 2 based on notched light panel projections 26E receiving hooked mounting plate projections 10D and/or notched mounting plate projection 10C receiving light panel projection lever 26F. For example, light panel 20 may be secured adjacent to mounting plate 2 based on notched light panel projections 26E receiving hooked mounting plate projections 10D and notched mounting plate projection 10C receiving light panel projection lever 26F.

Cables 30 may or may not be necessary for installation of light panel 20. For example, light panel 20 may be installed without cables 30. Light panel 20 may be installed without cables 30 based on notched light panel projections 26E receiving hooked mounting plate projections 10D, light panel 20 rotating towards mounting plate 2 about the connect between notched mounting plate projections 26E and hooked mounting plate projections 10D, and notched mounting plate projections 10C receiving light panel projection lever 26F. Circumventing use of cable 30 may improve ease of installation by removing the necessity of installing, managing, and/or detaching cables 30 as a temporary securement means between light panel 20 and mounting plate 2.

Low voltage connector 24 may be located on a top surface 20A of light panel 20. For example, low voltage driver outlet 6 may extend from top surface 20A of light panel 20. Low voltage connector 24 may align with electronic driver 4 (e.g., which may be located on a bottom surface 2B of mounting plate 2). Rotation of light panel 20 towards mounting plate 2, about an connect between hooked mounting plate projections 10D and notched light panel projection 26E, may cause electronic driver 4 and low voltage connector 24 to electrically and/or mechanically connect. Put another way, rotation of light panel 20 towards mounting plate 2, about a connection between hooked mounting plate projections 10D and notched light panel projection 26E, may cause electronic driver 4 and low voltage connector 24 to electrically connect. Rotation of light panel 2, about a connection between hooked mounting plate projections 10D and notched light panel projection 26E, away from light panel 20 may cause electronic driver 4 and low voltage connector 24 to detach. Put another way, rotation of light panel 20 towards mounting plate 2, about an connect between hooked mounting plate projections 10D and notched light panel projection 26E, may cause electronic driver 4 and low voltage connector 24 to electrically and/or mechanically disconnect. FIG. 5B depicts another top-down perspective view of a mounting plate and a light panel of a second embodiment discussed herein.

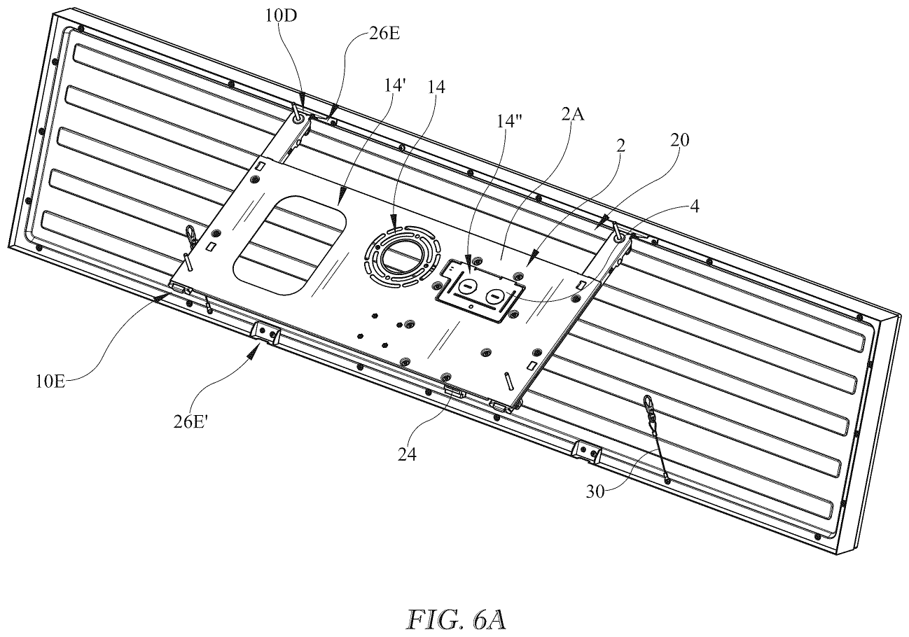

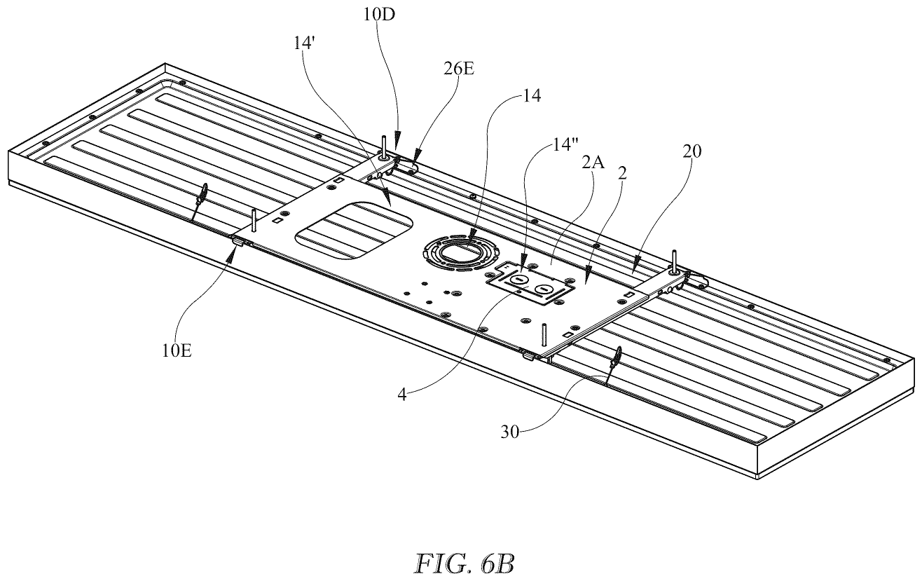

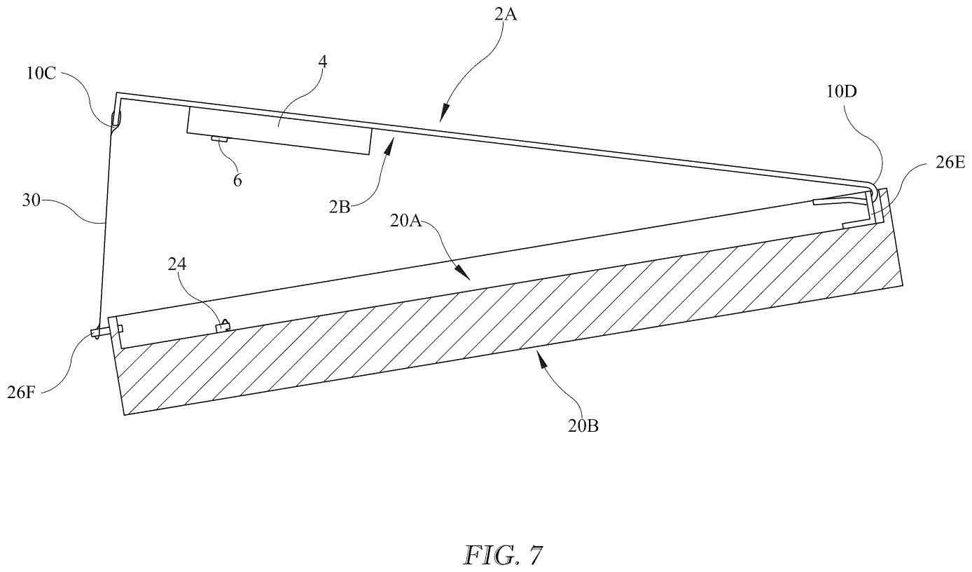

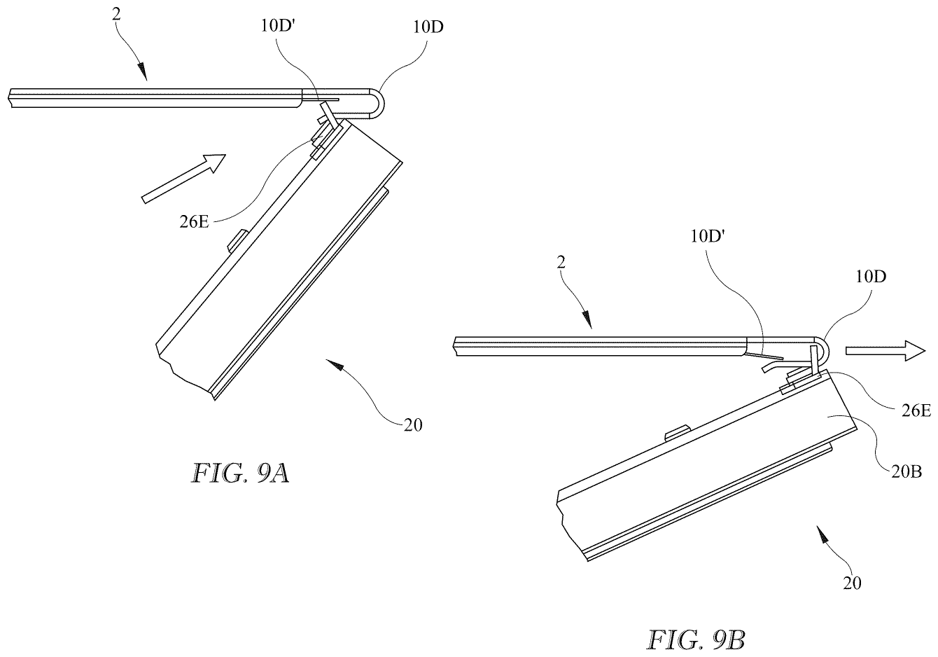

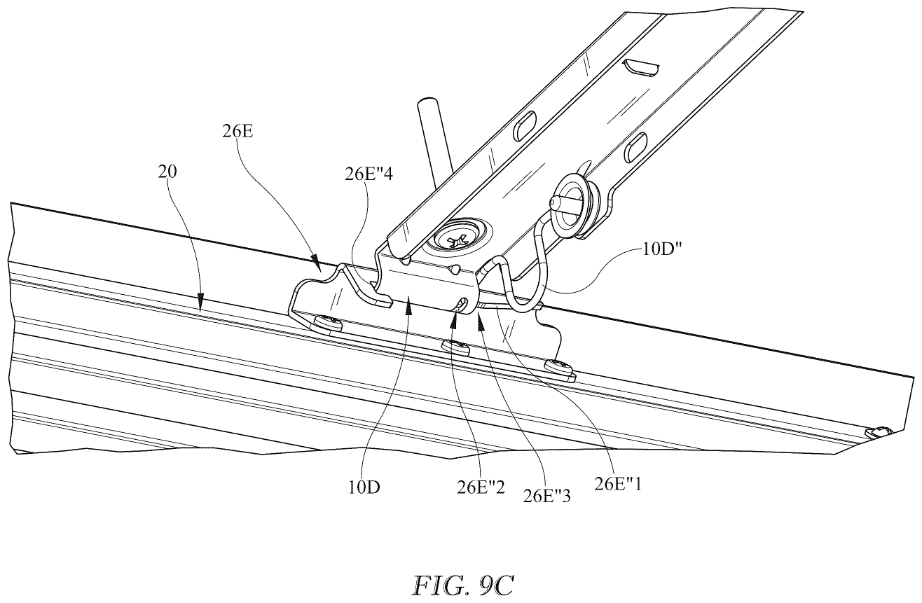

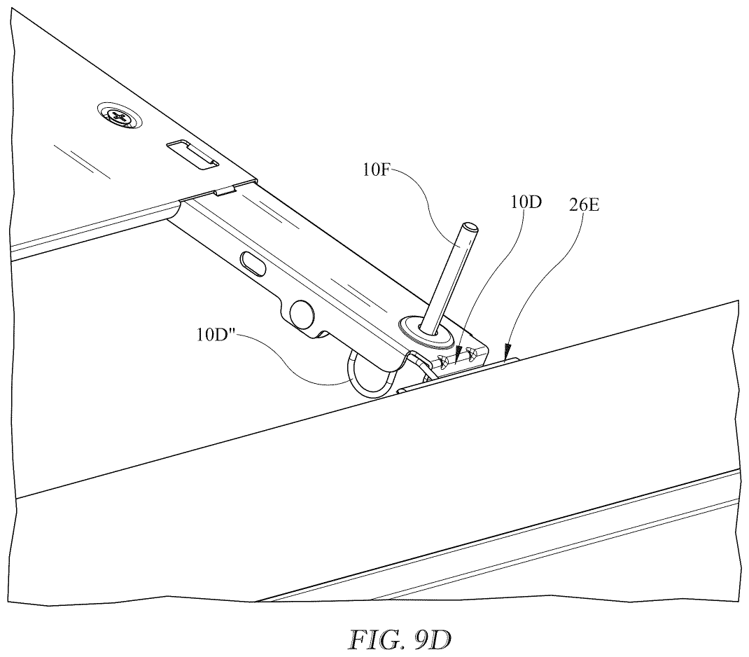

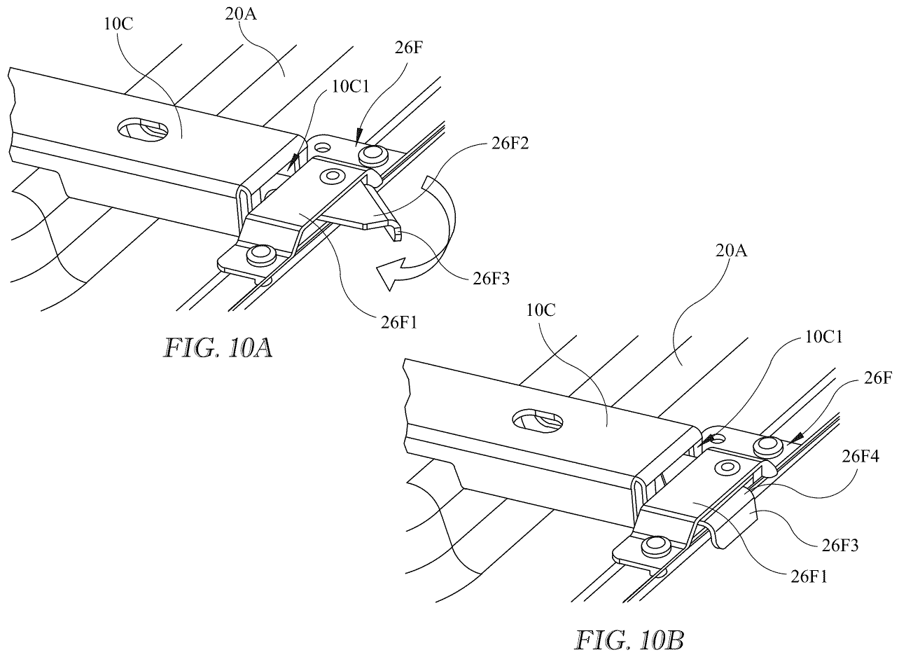

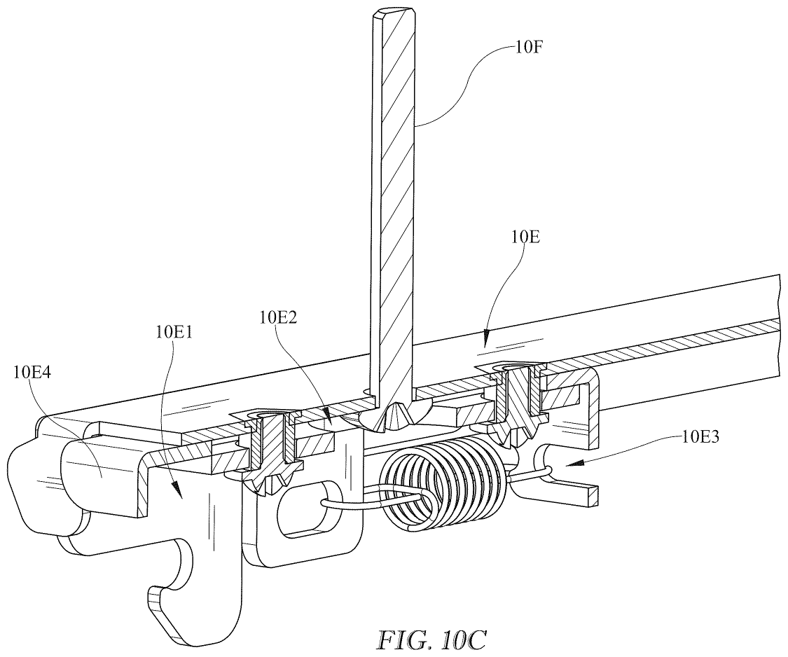

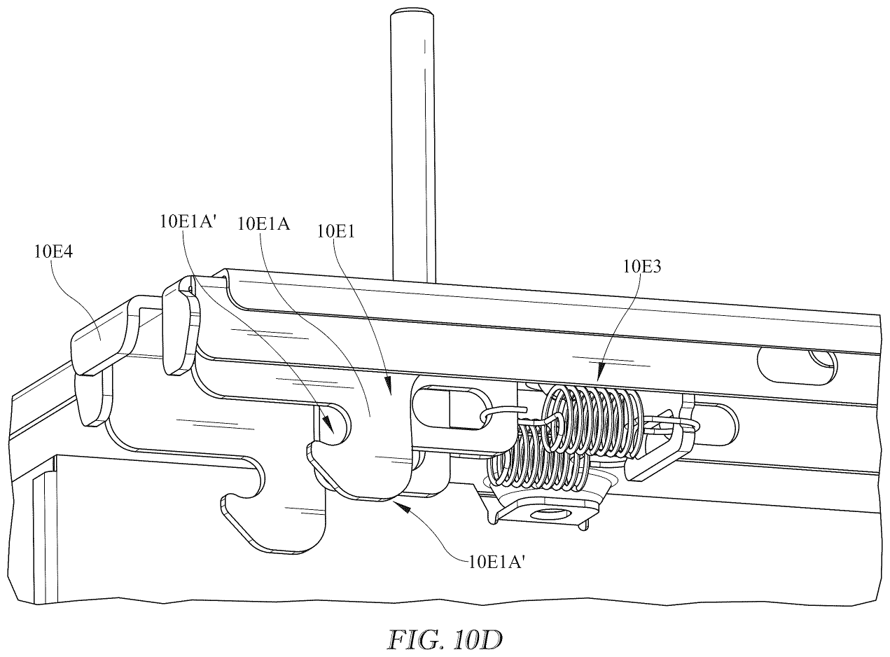

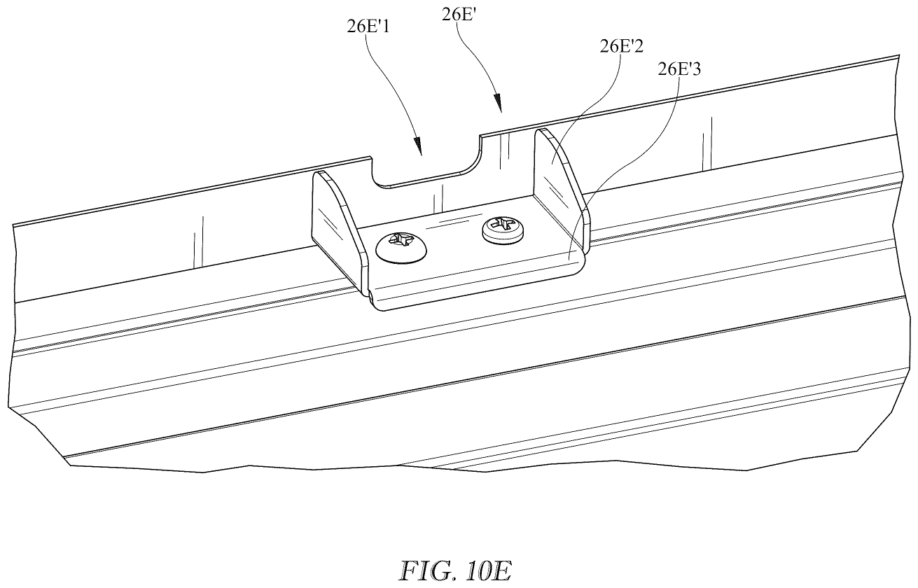

FIG. 6A depicts a top-down perspective view of a mounting plate and a light panel of a second embodiment discussed herein with modifications. Mounting plate 2 may include one or more hooked mounting plate projections 10D with one or more hooked mounting plate latches (depicted more directly in FIGS. 9C and 9D), and light panel 20 may include one or more notched light panel projections 26E with one or more notches (depicted more directly in FIGS. 9C and 9D) for receiving one or more hooked mounting plate latches. Hooked mounting plate projection 10D and notched light panel projection 26E may be mechanically connected. Additionally, mounting plate 2 may include a spring assisted mounting plate projection 10E (depicted more directly in FIGS. 10C and 10D), and light panel 20 may include another notched light panel projection 26E′ (depicted more directly in FIG. 10E). Spring assisted mounting plate projections 10E and notched light panel projections 26E′ may be mechanically connected. One or more cables 30 may be configured to connect light panel 20 with one or more of mounting plate 2 and/or another surface. Mounting plate 2 may include mounting plate aperture 14 and/or another mounting plate aperture 14′. Top surface 2A of mounting plate 2 may also provide one or more electronic driver access apertures/door 6B for accessing electronic driver 4.

FIG. 6B depicts another top-down perspective view of a mounting plate and a light panel of a second embodiment discussed herein. Notched light panel projections 26E′ may not be visible based on connection with spring assisted mounting plate projections 10E. Mounting plate 2 and light panel 20 may be electrically connected simultaneous to and/or subsequent to mechanical connection(s).

FIG. 7 depicts a side view of a mounting plate and a light panel of a second embodiment discussed herein. Low voltage connector 24 may align with low voltage driver outlet 6. Low voltage connector 24 may connect with low voltage driver outlet 6 based on rotation of light panel 20 towards mounting plate 2 about a connection between hooked mounting plate projection 10D and notched light panel projection 26E. Low voltage connector 24 may connect with low voltage driver outlet 6 based on rotation of light panel 20 away from mounting plate 2 about a connection between hooked mounting plate projection 10D and notched light panel projection 26E.

For example, FIG. 7 depicts low voltage connector 24 aligning with low voltage driver outlet 6 such that rotation of light panel 20 about a hinged connection of hooked mounting plate projection 10D and notched light panel projections 26E may cause low voltage driver outlet 6 to connect with low voltage connector 24. At the very least, rotation of light panel 20 towards mounting plate 2 about a hinged connection of hooked mounting plate projection 10D may cause light panel 20 to become substantially adjacent and/or level with mounting plate 2. Put another way, light panel 20 and mounting plate 2 may be positioned to occupy a plane that is parallel (or substantially parallel) with mounting plate 2. Minor repositioning of light panel 20 relative to mounting plate 2 subsequent to light panel 20 and mounting plate 2 becoming substantially adjacent and level may cause low voltage outlet 6 and low voltage connector 24 to become aligned. Based on low voltage outlet 6 and low voltage connector 24 becoming aligned, low voltage outlet 6 and low voltage connector 24 may be connected based on displacement of low voltage connector 24 into low voltage outlet 6.

Although cables 30 are depicted in FIG. 7, they may not be necessary. For example, light panel 20 may hang from mounting plate 2 via a hooked connection between hooked mounting plate projection 10D and notched light panel projection 26E. Light panel 20 may hang substantially perpendicular to mounting plate 2 based on the hooked connection only connecting one side of each of the mounting plate 2 and the light panel 20. Use of cables 30 may create a more acute angle between mounting plate 2 and light panel 20 subsequent to the hooked connection being formed. For example, cables 30 may tether notched mounting plate projection 10C and light panel projection lever 26F while an inspection is being performed prior to notched mounting plate projection 10C receiving light panel projection lever 26F. Alternatively, cables 30 may not be used, and light panel 20 may be brought from a substantially perpendicular position relative to mounting plate 2 to a substantially parallel position relative to mounting plate 2 by being displaced about the hooked connection between hooked mounting plate projection 10D and notched light panel projection 26E.

Light panel projection lever 26F may align with notched mounting plate projection 10C based on light panel 20 becoming adjacent to and/or substantially parallel with mounting plate 2. For example, based on light panel 20 being displaced against mounting plate 2 (e.g., based on rotation of light panel 20 towards mounting plate 2 about a hooked connection between notched light panel projection 26E and hooked mounting plate projection 10D), light panel projection lever 26F may align for receipt into notched mounting plate projection 10C. Notched mounting plate projection 10C may receive light panel projection lever 26F based on light panel projection lever 26F aligning for receipt into notched mounting plate projection 10C.

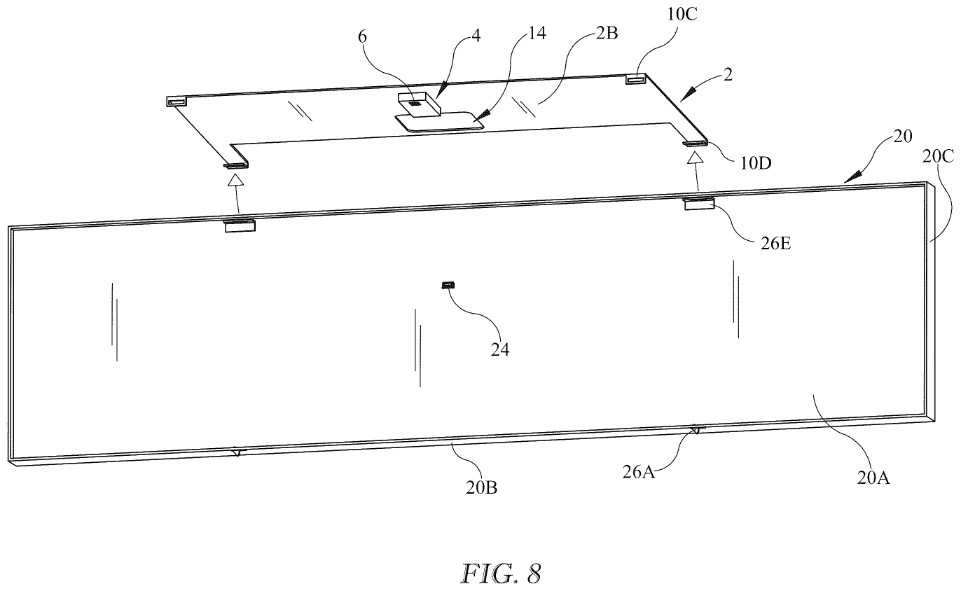

FIG. 8 depicts a front view of a mounting plate and a light panel of a second embodiment discussed herein. Hooked mounting plate projections 10D may align with notched light panel projections 26E. For example, hooked mounting plate projections 10D and notched light panel projections 26E may be spaced apart. Hooked mounting plate projections 10D may be located on opposing ends of a longitudinal side of mounting plate 2. Notched light panel projections 26E may be located on a longitudinal side of light panel 20 and may have a distance that is equal to the distance of the hooked mounting plate projections 10D. Notched light panel projections 26E may be equidistant from a center of a longitudinal side 20B of light panel 20.

Mounting plate 2 may be installed on a ceiling surface before connecting with light panel 20. Mounting plate 2 may be electrically connected to a line voltage source before connecting with light panel 20. As depicted in FIG. 8, mounting plate 2 may be installed on a ceiling surface and electrically connected with an electricity source before connecting with light panel 20. Notched light panel projections 26E may receive hooked mounting plate projections 10D. Based on notched light panel projections 26E receiving hooked mounting plate projections 10D, light panel 20 may be rotated upwards about a connection between notched light panel projections 26E and hooked mounting plate projections 10D. Based on upward rotation of light panel 20, light panel projection levers 26F may align with notched mounting plate projections 10C. Light panel projection levers 26F may be displaced into notched mounting plate projections 10C (e.g., connecting), based on the alignment. Low voltage driver outlet 6 and low voltage connector 24 may also connect based on upward rotation of light panel 20 towards mounting plate 2.

Designs disclosed herein may enable electricity to be provided to light panel 20 based on connection between mounting plate 2 and light panel 20. Otherwise electricity may only be provided to light panel 20 based on a conductor of light panel 20 connecting with a line-voltage conductor extending through mounting plate 2, and a user physically managing and connecting the two connections. Additionally, designs discussed herein allow for simultaneous or nearly simultaneous electrical and mechanical connection between a mounting plate 2 and a light panel 20. Otherwise, a ceiling light fixture may need to be hung by cables adjacent to a mounting plate, and then electrical connections between an electricity source and a light panel may need to be managed, and subsequently mechanical connections between a mounting plate and a light panel may need to be managed. Accordingly, designs disclosed herein improve light structures, and ease and efficiency of installation.

FIG. 9A depicts an enlarged side view of a mounting plate and a light panel of a second embodiment discussed herein. Hooked mounting plate projections 10D may include a locking tab 10D′. Locking tab 10D′ may be displaced to an open position while notched light panel projection 26E receives hooked mounting plate projection 10D. Locking tab 10D′ may return to a previous closed position (either manually, or automatically via natural spring and/or elastic forces, etc.) once notched light panel projection 26E receives hooked mounting plate projection 10D. While in a closed position, locking tab 10D′ may prevent notched light panel projection 26E from detaching from hooked mounting plate projection 10D. Put another way, notched light panel projection 26E may not detach from hooked mounting plate projection 10D while locking tab 10D′ closes a gap in hooked mounting plate projection 10D that allows notched light panel projections 26E to receive hooked mounting plate projection 10D. Locking tab 10D′ may prevent light panel 20 from detaching from mounting plate 2 during installation. For example, locking tab 10D′ may prevent light panel 20 from falling off of hooked mounting plate projection 10D if light panel 20 is accidentally shifted towards an opening of hooked mounting plate projection 10D.

FIG. 9B depicts an enlarged side view of a mounting plate and a light panel of a second embodiment discussed herein. Notched light panel projection 26E may be detached from hooked mounting plate projection 10D based on locking tab 10D′ being displaced to an open position. For example, notched light panel projection 26E may slide off of hooked mounting plate projection 10D based on locking tab 10D′ being displaced and creating an opening for notched light panel projection 26E to slide off of hooked mounting plate projection 10D.

FIG. 9C depicts a perspective view of a hooked mounting plate projection 10D, a hooked mounting plate latch 10D″, and a notched light panel projection 26E. As discussed, mounting plate 2 may include a hooked mounting plate projection 10D. In some implementations, mounting plate 2 may also include a hooked mounting plate latch 10D″, which may be adjacent to hooked mounting plate projection 10D. Light panel 20 may include notched light panel projection 26E, which may be shaped like a letter “U” turned on its side (e.g., turned 90 degrees). Notched light panel projection 26E may include a sloped edge 26E″1, a latch notch 26E″2, a straight edge 26E″3, and/or a stopper edge 26E″4.

Light panel 20 may be positioned such that sloped edge 26E″1 of notched light panel projection 26E may be adjacent to hooked mounting plate projection 10D. Hooked mounting plate projection 10D may interface with sloped edge 26E″1, and the slope of sloped edge 26E″1 may allow for a greater tolerance of error when attempting to interface hooked mounting plate projection 10D with notched light panel projection 26E. Hooked mounting plate latch 10D″ may also interface with sloped edge 26E″1. Subsequent to interfacing with sloped edge 26E″1, hooked mounting plate projection 10D may interface with straight edge 26E″3, and hooked mounting plate latch 10D″ may interface with latch notch 26E″2. Eventually, hooked mounting plate projection 10D may interface with stopper edge 26E″4, which may prevent notched light panel projection 26E from sliding past a remainder to hooked mounting plate projection 10D.

Interface between hooked mounting plate latch 10D″ and latch notch 26E″2 may also prevent notched light panel projection 26E from sliding back off of hooked mounting plate projection 10D. In some implementations, interface between hooked mounting plate latch 10D″ and latch notch 26E″2 may be ceased based on repositioning of hooked mounting plate latch 10D″ out of latch notch 26E″2. While hooked mounting plate latch 10D″ is out of latch notch 26E″2, notched light panel projection 26E may slide back off of hooked mounting plate projection 10D. In some implementations, hooked mounting plate latch 10D″ may be contoured (e.g., arcuately) to allow leverage (e.g., from a finger and/or tool) to be used to reposition hooked mounting plate latch 10D″ out of latch notch 26E″2.

FIG. 9D depicts another perspective view of a hooked mounting plate projection, a hooked mounting plate projection latch, and a notched light panel projection. In some implementations, anchor 10F may be installed subsequent to mounting plate 2 being placed adjacent to a surface. Anchor 10F may anchor mounting plate 2 to an adjacent surface. In some implementations, anchor 10F may anchor mounting plate 2 adjacent to a surface prior to light panel 20 interfacing with mounting plate 2.

FIG. 10A depicts an enlarged view of a mounting plate and a light panel of a second embodiment discussed herein. Mounting plate 2 and light panel 20 may connect using various components of various configurations, shapes, and sizes, that are located at various locations. For example, light panel 20 may include a light panel projection lever 26F located adjacent to and/or on a top surface 20A. Light panel projection lever 26F may include a bracket 26F1 and a hinge 26F2. Hinge 26F2 may hingedly rotate within, around, and/or about bracket 26F1. For example, hinge 26F2 may hingedly rotate within and/or about bracket 26F1.

Hinge 26F2 may hingedly rotate into notched mounting plate projection 10C. For example, notched mounting plate projection 10C may include a notch 10C1 that hinge 26F2 may rotate into. Receipt of hinge 26F2 into notch 10C1 may prevent and/or mitigate displacement of light panel 20 from mounting plate 2. Displacement of hinge 26F2 from notch 10C1 may enable and/or promote displacement of light panel 20 from mounting plate 2. Hinge 26F2 may include a handle 26F3 that may be used by a user to rotate hinge 26F2 into and out of notch 10C1.

FIG. 10B depicts an enlarged view of a mounting plate and a light panel of a second embodiment discussed herein. Light panel projection lever 26F may include a slider 26F4 that slides through bracket 26F1. For example, slider 26F4 may slide through bracket 26F1 into and out of notch 10C1. Receipt of slider 26F4 into notch 10C1 may prevent and/or mitigate displacement of light panel 20 from mounting plate 2. Displacement of slider 26F4 from notch 10C1 may enable displacement of light panel 20 from mounting plate 2. Slider 26F4 may also include a handle 26F3 that may be used by a user to slide slider 26F4 into and out of notch 10C1.

FIG. 10C depicts a cross-sectional perspective view of a spring assisted mounting plate projection. In some implementations, mounting plate 2 may include a spring assisted mounting plate projection 10E. Spring assisted mounting plate projection 10E may include an arm assembly 10E1, a sliding track assembly 10E2, a spring assembly 10E3, and a tab 10E4. Arm assembly 10E1 may slide within, about, about, and/or around sliding track assembly 10E2, such that a position and/or orientation of arm assembly 10E1 may be modified based on sliding within, about, and/or around sliding track assembly 10E2. Spring assembly 10E3 may exert a spring force on arm assembly 10E1, such that arm assembly 10E1 may change position and/or orientation responsive to an external force, and may revert back to a position and/or orientation responsive to the external force being removed and based on the spring force exerted by spring assembly 10E3. Tab 10E4 provides an ergonomic surface which a user can push against to manually provide counter-force against the force of spring assembly 10E3. For example, tab 10E4 may allow arm assembly 10E1 to disengage with a notched light panel projection 26E′ (depicted subsequently in FIG. 10E). Tab 10E4 may allow a user to assert force overcoming that exerted by spring assembly 10E3, such that arm assembly 10E1 moves along, within, and/or about sliding track assembly 10E2. Accordingly, arm assembly 10E1 may disengage with a notched light panel projection 26E′ responsive to the user applying force to tab 10E4. In some implementations, tab 10E4 may be pushed and/or pulled in furtherance of overcoming spring force exerted by spring assembly 10E3 and displacing arm assembly 10E1.

FIG. 10D depicts another perspective view of the spring assisted mounting plate projection. Arm assembly 10E1 may include an arm 10E1A with a notched side 10E1A′ and a curved bottom 10E1A″.

FIG. 10E depicts a perspective view of a notched light panel projection. As arm assembly 10E1 approaches notched light panel projection 26E′, the curved bottom 10E1A″ of arm assembly 10E1 may interface with notched light panel projection 26E′ and force exerted via notched light panel projection 26E′ against curved bottom 10E1A″ may cause arm assembly 10E1 to be shifted relative to track assembly 10E2, such that notched light panel projection 26E′ will travel towards and eventually interface with notched side 10E1A′. Tab 10E4 may be pressed to cause arm assembly 10E1 to detract out of notched light panel projection 26E′. Notched light panel projection 26E′ may include a tab aperture 26E′1 so that tab 10E4 does not prevent notched light panel projection 26E′ and spring assisted mounting plate projection 10E from mechanically connecting (e.g., despite tab 10E4 extending further than the rest of spring assisted mounting plate projection 10E in some implementations). Notched light panel projection 26E′ may also include one or more walls 26E′2, which may mitigate and/or prevent spring assisted mounting plate projection 10E from being displaced during and/or subsequent to mechanical connection with notched light panel projection 26E′.

Notched light panel projection 26E′ may also include an interface plate 26E′3, which a curved bottom 10E1A″ of arm assembly 10E1 of spring assisted mounting plate projection 10E may interface with. Interface plate 26E′3 may be contoured to promote arm assembly 10E1 moving around and/or about interface plate 26E′3 in furtherance of facilitating receipt of interface plate 26E′3 within notched side 10E1A′ of arm 10E1A. For example, curved bottom 10E1A″ may interface with and glide against interface plate 26E′3, causing arm assembly 10E1 to move around and/or about interface plate 26E′3 until notched side 10E1A′ receives interface plate 26E′3. Mounting plate 2 and light panel 20 may be mechanically connected based on receipt of interface plate 26E′3 within notched side 10E1A′ of arm 10E1A. Interface plate 26E′3 may be disengaged from notched side 10E1A′ responsive to force being applied to tab 10E4.

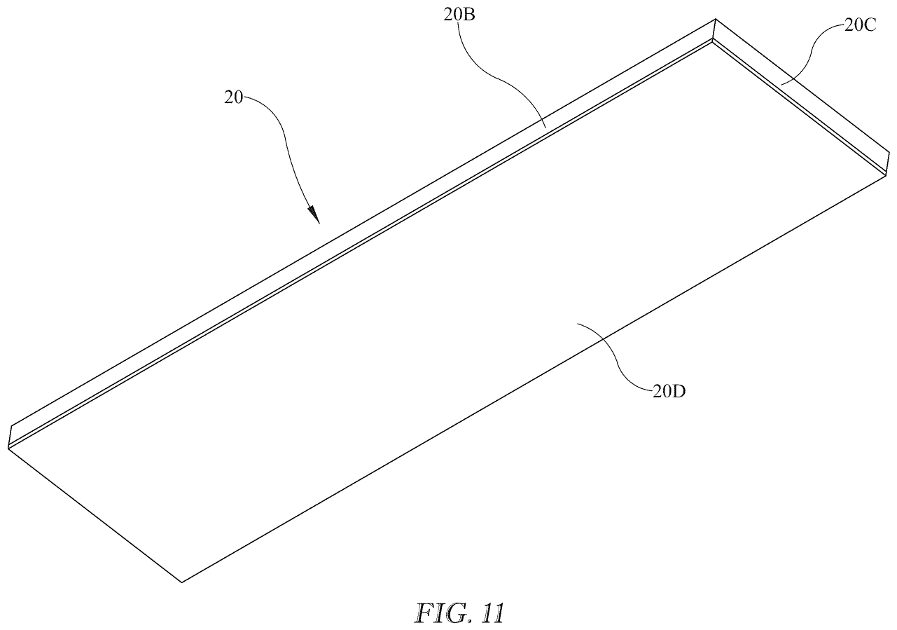

FIG. 11 is a bottom-up perspective view of a light panel of a second embodiment discussed herein.

Bottom surface 20D of light panel 20 may be flat. Light panel 20 may be rectangular. Light panel 20 may also have one or more non-flat surfaces, and may be a non-rectangular shape. For example, light panel 20 may have a curved bottom surface and/or be circular or ovular in shape.

FIG. 12 depicts circuitry of a light panel of a second embodiment discussed herein. Circuitry 32 may include one or more components that are electrically connected. As discussed previously, implementations herein may include a light source. For example, circuitry 32 may include one or more LEDs 34. LED 34 may be white and/or colored. Circuitry 32 may also include conduit connecting one or more components. Circuitry 32 may include low voltage connector 24. Low voltage connector 24 may provide electricity to circuitry 32 based on low voltage connector 24 being connected to low voltage driver outlet 6. Low voltage driver outlet 6 may be connected to an electricity source via electronic driver 4, based on electronic driver 4 being connected to a line voltage source via conductor 8. Aspects of circuitry 32 may also be included in one or more other embodiments discussed herein.

FIG. 13 depicts a schematical representation of circuitry of one or more light panel embodiments discussed herein. Circuitry 40 may include one or more of a noise filter circuitry 42, metal oxide varistor circuitry 44, voltage converter circuitry 46, flyback controller circuitry 48, dimming depth compensation circuity 50, open start circuitry 52, active damping circuitry 54, transformer circuitry 56, and/or output voltage circuitry 58. Circuitry 40 may include, and/or be in electrical connection with, circuitry 32 of FIG. 12.

Noise filter circuitry 42 may receive line voltage inputs and may include capacitors and/or inductors, which may be used to filter high and low frequency signals. Filtering high and low frequency signals using noise filter circuitry 42 may reduce electrical noise within circuitry 40, and may improve accuracy and/or precision of one or more components connected therewith (e.g., may increase accuracy and/or precision of an emission by an LED connected with circuitry 40). Metal oxide varistor circuitry 44 may include a metal oxide varistor, which may be used as a variable input switch (e.g., a dimmer) for circuitry 40. Voltage converter circuitry 46 may include one or more resistors, diodes, capacitors, and/or inductors, which may be used to convert voltage(s) within circuitry 40. Flyback controller circuitry 48 may include an IC chip, processor, PCB, etc., which may receive one or more inputs and may emit one or more outputs based on the input(s) received. Flyback controller circuitry 48 may also include one or more resistors, diodes, capacitors, inductors, transistors, and/or FETs, which may modify one or more outputs, such as an auxiliary signal output and/or a flyback driver output.

Dimming depth compensation circuitry 50 may include one or more resistors, capacitors, and/or diodes, which may modify a dimming depth of one or more LEDs connected with circuitry 40 responsive to adjustments of one or more components discussed herein, such as metal oxide varistor circuitry 44. Open start circuitry 52 may facilitate exchange of a signal in response to one or more aspects of circuit 40 being electrically open. Open start circuitry 52 may include one or more resistors and may exchange and/or modify a signal being exchanged with flyback controller circuitry 48. Active damping circuitry 54 may reduce resonance and/or reduce output impedance associated with circuitry 40, and may include one or more resistors, diode, capacitors, and/or transistors. Active damping circuitry 54 may also reduce resonance within circuitry 40. Active damping circuitry 54 may reduce output impedance associated with voltage converter circuitry 46.

Transformer circuitry 56 may transform voltage and/or current of an input provided by one or more components of circuitry 40. Output voltage circuitry 58 may provide an output voltage to one or more components discussed herein, such as an LED 34. For example, an LED 34 may connect with Vo+ and/or Vo−. Output voltage circuitry 58 may include one or more capacitors, inductors, diodes, resistors, transistors, FETs. Circuitry 40 may include one or more equivalent circuits and/or components, and/or may be connected with one or more other circuits and/or electrical components.

Disclosure discussed herein is non-limiting. For example, exact configurations, shapes, sizes, locations, etc., of components discussed herein are non-limiting examples. Production of similar configurations, shapes, sizes, of components discussed herein is contemplated. Rearrangement, relocation, substitution, removal, and/or addition of components discussed herein, even across different embodiments, is also contemplated by this disclosure.

In some implementations, a light fixture may comprise: a mounting plate having an electronic driver and one or more mounting plate projections, wherein the electronic driver includes a low voltage driver outlet; and a light panel having a light source, a channel, a low voltage connector, and one or more light panel projections, wherein the channel receives the electronic driver, wherein the low voltage connector and the low voltage driver outlet align for electrical connection based on receipt of the driver within the channel, and wherein the one or more light panel projections and the one or more mounting plate projections align for mechanical connection based on receipt of the electronic driver within the channel.

In some implementations, the mounting plate and the light panel are mechanically connected based on mechanical connection of the one or more light panel projections and the one or more mounting plate projections. In some implementations, the mounting plate and the light panel are electrically connected based on electrical connection of the low voltage connector and the low voltage driver outlet. In some implementations, the one or more light panel projections include a first set of two light panel projections on a first side of the light panel and a second set of two light panel projections on a second side of the light panel, and the one or more mounting plate projections include a first set of two mounting plate projections on a first side of the mounting plate and a second set of two mounting plate projections on a second side of the mounting plate, and wherein the first set of two light panel projections connect with the first set of two mounting plate projections and the second set of two light panel projections connect with the first set of two mounting plate projections. In some implementations, electrical connection of the low voltage connector and the low voltage driver outlet occurs simultaneously with the first set of two panel projections connecting with the first set of two mounting plate projections and the second set of two panel projections connecting with the second set of two mounting plate projections.

In some implementations, mechanical connection, of one or more of the first set of two light panel projections with the first set of two mounting plate projections, and the second set of two light panel projections with the second set of two mounting plate projections, is prohibited based on the electronic driver being outside of the channel. In some implementations, electrical connection, of the low voltage connector and the low voltage driver outlet, is prohibited based on the electronic driver being outside of the channel. In some implementations, the mounting plate receives one or more fasteners securing the mounting plate to an adjacent surface.

In some implementations, the surface is a ceiling having a junction box. In some implementations, the light source includes one or more LEDS. In some implementations, the LEDs are white or colored. In some implementations, the channel is longer than the electronic driver.

In some implementations, based on receipt of the electronic driver within the channel, the electronic driver slides within the channel, and the low voltage connector and the low voltage driver outlet electrically connect based on the electronic driver sliding within the channel. In some implementations, connection between the low voltage connector and the low voltage driver outlet is detachable via a mechanical switch. In some implementations, the mechanical switch is included in the light panel. In some implementations, the mechanical switch is included on a side of the light panel.

In some implementations, a light fixture may comprise: a mounting plate having an electronic driver and a mounting plate projection, wherein the electronic driver includes an electrical driver outlet; and a light panel having a light source, a channel that receives the electronic driver, a low voltage connector aligning with the electrical driver outlet, and a light panel projection aligning with the mounting plate projection, wherein the low voltage connector and the electrical driver outlet align for electrical connection based on receipt of the electronic driver within the channel, and wherein the light panel projection and the mounting plate projection align for mechanical connection based on receipt of the electronic driver within the channel.

In some implementations, the mounting plate and the light panel are mechanically connected based on the light panel projection connecting with the mounting plate projection. In some implementations, the mounting plate and the light panel are electrically connected based on the low voltage connector connecting with the electrical driver outlet.

In some implementations, a light fixture may comprise: a mounting plate having an electronic driver that includes an outlet; and a light panel having a light source, a channel that receives the electronic driver, and a low voltage connector that aligns for electrical connection with the outlet of the electronic driver based on the electronic driver being received in the channel.

In some implementations, a light fixture may comprise: a mounting plate having one or more mounting plate projections and an electronic driver having a low voltage driver outlet, wherein a conductor of the mounting plate connects the electronic driver with an electricity source, and a light panel having a light source, a low voltage connector that aligns with the low voltage driver outlet for at least electrical connection, and one or more light panel projections that align with the one or more mounting plate projections for mechanical connection, wherein the one or more light panel projections are located on a first side of the light panel and the one or more mounting plate projections are located on a first side of the mounting plate, and wherein the low voltage connector is located on a second side of the light panel and the low voltage driver outlet is located on a second side of the mounting plate, and wherein the low voltage connector electrically connects with the low voltage driver outlet based on rotation of the second side of the light panel towards the second side of the mounting plate about a connection between the one or more light panel projections and the one or more mounting plate projections.

In some implementations, the mounting plate and the light panel are mechanically connected based the connection between the one or more light panel projections and the one or more mounting plate projections, and wherein the mounting plate and the light panel are at least electrically connected based on a connection between the low voltage connector and the low voltage driver outlet. In some implementations, a light fixture may further comprise one or more additional light panel projections located on the second side of the light panel and one or more additional mounting plate projections located on the second side of the mounting plate.

In some implementations, the additional light panel projections align with the additional mounting plate projections for mechanical connection. In some implementations, the one or more mounting plate projections are located on a first side of the mounting plate include hooks and the one or more light panel projections that are located on a first side of the light panel include notches that receive the hooks. In some implementations, the low voltage connector electrically disconnects with the low voltage driver outlet based on rotation of the second side of the light panel away from the second side of the mounting plate about the connection between the one or more light panel projections and the one or more mounting plate projections.

In some implementations, the mounting plate receives one or more fasteners securing the mounting plate to an adjacent surface. In some implementations, the adjacent surface is a junction box. In some implementations, the light source includes one or more LEDS. In some implementations, the LEDS are white or colored. In some implementations, the low voltage driver outlet extends from the mounting plate. In some implementations, the low voltage connector extends from the light panel.

In some implementations, a light fixture may comprise: a mounting plate having: an electronic driver including a low voltage driver outlet, a hooked mounting plate projection, and a notched mounting plate projection; and a light panel having: a light source, a notched light panel projection aligning with the hooked mounting plate projection for mechanical connection, and a light panel projection lever aligning with the notched mounting plate projection for mechanical connection, and a low voltage connector that aligns with the low voltage driver outlet for electrical connection.

In some implementations, the mounting plate and the light panel are mechanically connected based on one or more of a mechanical connection of the hooked mounting plate projection with the notched light panel projection, and a mechanical connection of the notched mounting plate projection with the light panel projection lever. In some implementations, the mounting plate and the light panel are electrically connected based on electrical connection of the low voltage connector and the low voltage driver outlet. In some implementations, the low voltage connector and the low voltage outlet connect based on rotation of the light panel rotating towards the mounting plate about a connection between the notched light panel projection and the hooked mounting plate projection. In some implementations, the electrical connection of the low voltage connector and the low voltage driver outlet is disconnected based on rotation of the light panel away from the mounting plate using the connection between the notched light panel projection and the hooked mounting plate projection. In some implementations, the mounting plate receives one or more fasteners securing the mounting plate to an adjacent surface. In some implementations, the adjacent surface is a junction box.

In some implementations, a light fixture may include: a mounting plate including: an electronic driver including a low voltage driver outlet, a hooked mounting plate projection, and a notched mounting plate projection; and a light panel including: an LED, a low voltage connector that aligns with the low voltage outlet for electrical connection, a notched light panel projection that receives the hooked mounting plate projection, and a light panel projection lever that is received by the notched mounting plate projection.

1-20. (canceled)

21. A light fixture comprising:
a mounting plate having one or more mounting plate projections and an electronic driver having a low voltage driver outlet,
wherein a conductor of the mounting plate connects the electronic driver with an electricity source, and
a light panel having a light source, a low voltage connector that aligns with the low voltage driver outlet for at least electrical connection, and one or more light panel projections that align with the one or more mounting plate projections for mechanical connection,
wherein the one or more light panel projections are located on a first side of the light panel and the one or more mounting plate projections are located on a first side of the mounting plate, and
wherein the low voltage connector is located on a second side of the light panel and the low voltage driver outlet is located on a second side of the mounting plate, and
wherein the low voltage connector electrically connects with the low voltage driver outlet based on rotation of the second side of the light panel towards the second side of the mounting plate about a connection between the one or more light panel projections and the one or more mounting plate projections.

22. The light fixture of claim 21, wherein the mounting plate and the light panel are mechanically connected based the connection between the one or more light panel projections and the one or more mounting plate projections, and wherein the mounting plate and the light panel are at least electrically connected based on a connection between the low voltage connector and the low voltage driver outlet.

23. The light fixture of claim 21, further comprising one or more additional light panel projections located on the second side of the light panel and one or more additional mounting plate projections located on the second side of the mounting plate.

24. The light fixture of claim 23, wherein the additional light panel projections align with the additional mounting plate projections for mechanical connection.

25. The light fixture of claim 22, wherein the one or more mounting plate projections are located on a first side of the mounting plate include hooks and the one or more light panel projections that are located on a first side of the light panel include notches that receive the hooks.

26. The light fixture of claim 25, wherein the low voltage connector electrically disconnects with the low voltage driver outlet based on rotation of the second side of the light panel away from the second side of the mounting plate about the connection between the one or more light panel projections and the one or more mounting plate projections.

27. The light fixture of claim 21, wherein the mounting plate receives one or more fasteners securing the mounting plate to an adjacent surface.

28. The light fixture of claim 27, wherein the adjacent surface is a junction box.

29. The light fixture of claim 21, wherein the light source includes one or more LEDS.

30. The light fixture of claim 29, wherein the LEDS are white or colored.

31. The light fixture of claim 21, wherein the low voltage driver outlet extends from the mounting plate.

32. The light fixture of claim 31, wherein the low voltage connector extends from the light panel.

33. A light fixture comprising:
a mounting plate having:
an electronic driver including a low voltage driver outlet,
a hooked mounting plate projection, and
a notched mounting plate projection; and
a light panel having:
a light source,
a notched light panel projection aligning with the hooked mounting plate projection for mechanical connection, and
a light panel projection lever aligning with the notched mounting plate projection for mechanical connection, and
a low voltage connector that aligns with the low voltage driver outlet for electrical connection.

34. The light fixture of claim 33, wherein the mounting plate and the light panel are mechanically connected based on one or more of a mechanical connection of the hooked mounting plate projection with the notched light panel projection, and a mechanical connection of the notched mounting plate projection with the light panel projection lever.

35. The light fixture of claim 34, wherein the mounting plate and the light panel are electrically connected based on electrical connection of the low voltage connector and the low voltage driver outlet.

36. The light fixture of claim 33, wherein the low voltage connector and the low driver voltage outlet connect based on rotation of the light panel rotating towards the mounting plate about a connection between the notched light panel projection and the hooked mounting plate projection.

37. The light fixture of claim 36, wherein the electrical connection of the low voltage connector and the low voltage driver outlet is disconnected based on rotation of the light panel away from the mounting plate using the connection between the notched light panel projection and the hooked mounting plate projection.

38. The light fixture of claim 33, wherein the mounting plate receives one or more fasteners securing the mounting plate to an adjacent surface.

39. The light fixture of claim 38, wherein the adjacent surface is a junction box.

40. A light fixture including:
a mounting plate including:
an electronic driver including a low voltage driver outlet,
a hooked mounting plate projection, and
a notched mounting plate projection; and
a light panel including:
an LED,
a low voltage connector that aligns with the low voltage driver outlet for electrical connection,
a notched light panel projection that receives the hooked mounting plate projection, and
a light panel projection lever that is received by the notched mounting plate projection.
